(19) United States
(12) Patent Application Publication
(10) Pub. No.: US 2026/0105415 A1
(43) Pub. Date: Apr. 16, 2026

(54) INFORMATION PROCESSING APPARATUS, INFORMATION PROCESSING METHOD, AND NON-TRANSITORY COMPUTER-READABLE STORAGE MEDIUM

(71) Applicant: NEC Corporation, Tokyo (JP)

(72) Inventor: Shohei MITANI, Tokyo (JP)

(73) Assignee: NEC Corporation, Tokyo (JP)

(21) Appl. No.: 19/346,895

(22) Filed: Oct. 1, 2025

(30) Foreign Application Priority Data
Oct. 10, 2024 (JP) 2024-178480

(51) Int. Cl. G06Q 10/10; G06F 8/10; G06N 5/04; G06Q 10/0637

(52) U.S. Cl. CPC G06Q 10/103; G06F 8/10; G06N 5/04; G06Q 10/06375

(57) ABSTRACT

An information processing apparatus includes a data acquisition means, an inference means, and a visualization means. The data acquisition means acquires relationship information between a plurality of design tasks constituting a design flow of a system, design results of the design tasks, and input information for executing the design tasks, the input information including at least natural language. The inference means infers, based on the acquired relationship information, design results, and input information, correspondence relationships spanning the design tasks with respect to each part of the design results and the input information. The visualization means displays, based on the inferred correspondence relationships, a correspondence structure with respect to the design results and the input information over an entirety of the system.

### INCORPORATION BY REFERENCE

This application is based upon and claims the benefit of priority from Japanese Patent Application No. 2024-178480, filed on Oct. 10, 2024, the disclosure of which is incorporated herein in its entirety by reference.

### TECHNICAL FIELD

The present disclosure relates to an information processing apparatus, an information processing method, and a non-transitory computer-readable storage medium.

### BACKGROUND ART

In a system development project, risk management plays an important role in ensuring the success of the project.

As a method for project risk assessment, there is a case where a method of aggregating evaluation values of people based on development documents or the like is used (for example, see Patent Literature 1 (JP2022-180289)).

In the field of text quality analysis, a method for evaluating the quality of documents or the like has also been proposed, in which natural language processing technology is used to learn from good examples and bad examples.

However, in the development tasks of a complex system, hierarchical dependencies exist. Therefore, in a case where defects exist in the deliverables at each stage, risks related to quality, such as rework, failure to meet a delivery deadline, and failure to meet performance, may arise. For this reason, it is necessary to improve the relationships of each stage of the development process and to enhance the visibility of the areas to be modified.

### SUMMARY

It is a main object of the present disclosure to provide an information processing apparatus, an information processing method, and a non-transitory computer-readable storage medium that contribute to improving the relationships of each stage of a development process and the visibility of the areas to be modified.

According to a first aspect of the present disclosure, there is provided an information processing apparatus including: a data acquisition means that acquires relationship information between a plurality of design tasks constituting a design flow of a system, design results of the design tasks, and input information for executing the design tasks, the input information including at least natural language; an inference means that infers, based on the acquired relationship information, design results, and input information, correspondence relationships spanning the design tasks with respect to each part of the design results and the input information; and a visualization means that displays, based on the inferred correspondence relationships, a correspondence structure with respect to the design results and the input information over an entirety of the system.

According to a second aspect of the present disclosure, there is provided an information processing method of an information processing apparatus, the information processing method including: acquiring relationship information between a plurality of design tasks constituting a design flow of a system, design results of the design tasks, and input information for executing the design tasks, the input information including at least natural language; inferring, based on the acquired relationship information, design results, and input information, correspondence relationships spanning the design tasks with respect to each part of the design results and the input information; and displaying, based on the inferred correspondence relationships, a correspondence structure with respect to the design results and the input information over an entirety of the system.

According to a third aspect of the present disclosure, there is provided a non-transitory computer-readable storage medium storing a program causing a computer mounted on an information processing apparatus to perform processing for: acquiring relationship information between a plurality of design tasks constituting a design flow of a system, design results of the design tasks, and input information for executing the design tasks, the input information including at least natural language; inferring, based on the acquired relationship information, design results, and input information, correspondence relationships spanning the design tasks with respect to each part of the design results and the input information; and displaying, based on the inferred correspondence relationships, a correspondence structure with respect to the design results and the input information over an entirety of the system.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an outline of an example embodiment;

FIG. 2 is a flowchart illustrating an operation of an example embodiment;

FIG. 3 is a diagram illustrating an example of a schematic configuration of an information processing system according to an embodiment of the present disclosure;

FIG. 4 is a diagram illustrating an operation of the information processing system according to the embodiment of the present disclosure;

FIG. 5 is a diagram illustrating an example of a processing configuration of the information processing apparatus according to the embodiment of the present disclosure;

FIG. 6 is a diagram illustrating an example of a data structure according to the embodiment of the present disclosure;

FIG. 7 is a diagram illustrating an example of a screen displayed by the visualization unit according to the embodiment of the present disclosure;

FIG. 8 is a diagram illustrating an example of a screen displayed by the visualization unit according to the embodiment of the present disclosure;

FIG. 9 is a diagram illustrating an example of a screen displayed by the visualization unit according to the embodiment of the present disclosure;

FIG. 10 is a diagram illustrating an example of a screen displayed by the visualization unit according to the embodiment of the present disclosure;

FIG. 11 is a diagram illustrating an example of a data structure according to the embodiment of the present disclosure;

FIG. 12 is a diagram illustrating an example of a screen displayed by the visualization unit according to the embodiment of the present disclosure;

FIG. 13 is a diagram illustrating an example of a screen displayed by the visualization unit according to the embodiment of the present disclosure;

FIG. 14 is a diagram illustrating an example of a screen displayed by the visualization unit according to the embodiment of the present disclosure;

FIG. 15 is a flowchart illustrating an example of an operation of the information processing apparatus according to the embodiment of the present disclosure;

FIG. 16 is a diagram illustrating an example of a processing configuration of the information processing apparatus according to the embodiment of the present disclosure;

FIG. 17 is a diagram illustrating an example of a screen displayed by the visualization unit according to the embodiment of the present disclosure;

FIG. 18 is a flowchart illustrating an example of an operation of the information processing apparatus according to the embodiment of the present disclosure; and

FIG. 19 is a diagram illustrating an example of a hardware configuration of the information processing apparatus according to the present disclosure.

### EXAMPLE EMBODIMENT

First, an outline of an example embodiment will be described. In the following outline, various components are denoted by reference characters for the sake of convenience. That is, the following reference characters are used as examples to facilitate the understanding of the present disclosure. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

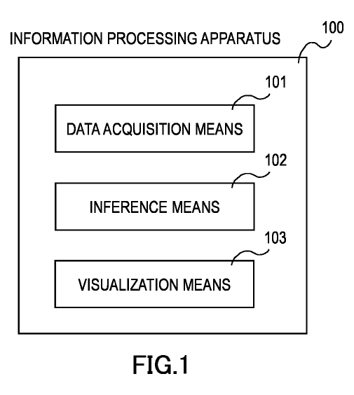

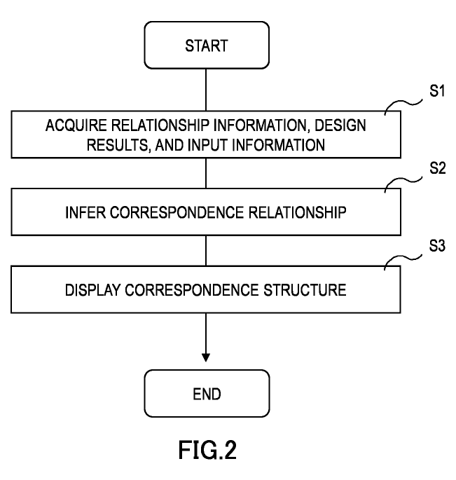

An information processing apparatus 100 according to an example embodiment includes a data acquisition means 101, an inference means 102, and a visualization means 103 (see FIG. 1). The data acquisition means 101 acquires relationship information between a plurality of design tasks constituting a design flow of a system, design results of the design tasks, and input information for executing the design tasks, the input information including at least natural language (step S1 in FIG. 2). The inference means 102 infers, based on the acquired relationship information, design results, and input information, correspondence relationships spanning the design tasks with respect to each part of the design results and the input information (step S2). The visualization means 103 displays, based on the inferred correspondence relationships, a correspondence structure with respect to the design results and the input information over an entirety of the system (step S3).

The information processing apparatus 100 infers correspondence relationships spanning a plurality of design tasks by using relationship information or the like between the design tasks in a development process. The information processing apparatus 100 visualizes and displays a correspondence structure over an entirety of the system based on the inferred correspondence relationships. As a result, relationships of each stage of the development process and visibility of areas to be modified are improved.

Hereinafter, specific example embodiments will be described in more detail with reference to drawings.

### First Example Embodiment

A first example embodiment will be described in more detail with reference to drawings.

### System Configuration and Schematic Operation

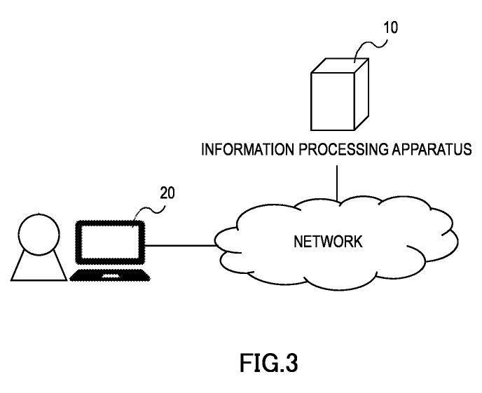

As shown in FIG. 3, the information processing system according to the first example embodiment includes an information processing apparatus 10 and a terminal 20.

The information processing apparatus 10 is an information processing apparatus that supports system design and deliverable management by a user. For example, the information processing apparatus 10 is a server installed on a network (on a cloud).

A user operates the terminal 20 to access the information processing apparatus 10. The user inputs various information into the information processing apparatus 10 and also acquires various information from the information processing apparatus 10.

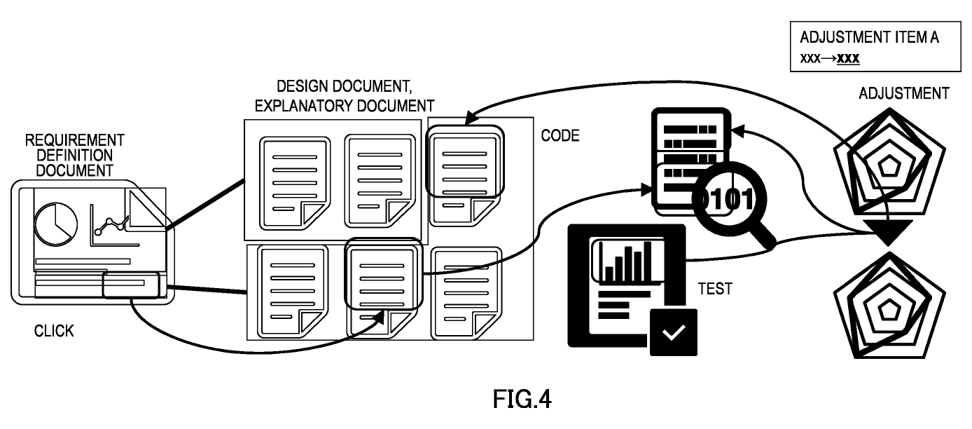

FIG. 4 is a conceptual diagram for explaining a value provided by the information processing apparatus 10 according to the embodiment of the present disclosure. In FIG. 4, the process of document creation and evaluation in a system development project is represented. In system development, the project starts with creation of a "requirement definition document" on the left side, proceeds through creation of a "design document, explanatory document" in the center, and then moves to creation of "code" and execution of "tests" on the right side.

In FIG. 4, the documents created at each stage are represented by a plurality of file icons. In addition, the relationships and dependencies between the documents (the plurality of file icons) are represented by arrows drawn between the plurality of documents.

In a portion of "code" shown in FIG. 4, a magnifying glass icon is arranged to indicate that examination and analysis of the code is performed.

"Test" is represented by a document icon with a check mark, meaning that confirmation of test results is performed.

In the upper right of FIG. 4, a frame labeled "adjustment item A" is described. The description "xxx --> xxx" written inside the frame indicates that a change or modification is performed.

In addition, at the right end of FIG. 4, two pentagonal icons are arranged together with a character string "adjustment." The icons represent that adjustment and optimization of the entire project are performed.

FIG. 4 visually represents a series of processes from document creation, coding, and testing at each stage of system development to final adjustment, and concisely illustrates relationships between respective elements and a flow of work.

The information processing apparatus 10 enables efficient project management by realizing, by a system, a management structure of a system development project as shown in FIG. 4.

Subsequently, details of the information processing apparatus 10 according to a first example embodiment will be described.

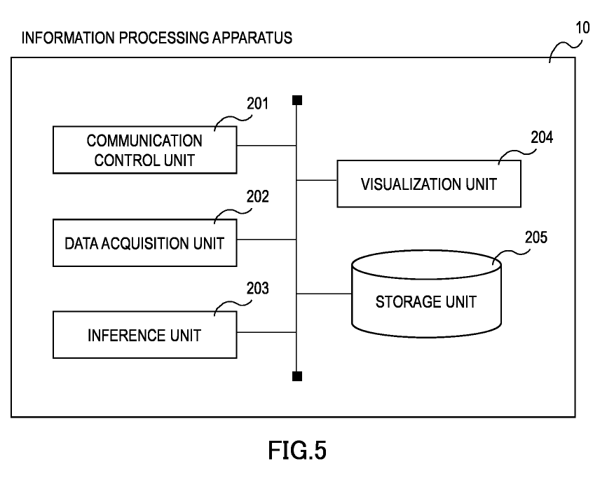

FIG. 5 is a diagram illustrating an example of a processing configuration (processing modules) of the information processing apparatus 10 according to an example embodiment disclosed in the present application. Referring to FIG. 5, the information processing apparatus 10 includes a communication control unit 201, a data acquisition unit 202, an inference unit 203, a visualization unit 204, and a storage unit 205.

The communication control unit 201 is means for controlling communication with other apparatuses. For example, the communication control unit 201 receives data (packets) from the terminal 20. In addition, the communication control unit 201 transmits data to the terminal 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The data acquisition unit 202 is means for acquiring data from a database or a user.

The inference unit 203 is means for inferring (presuming) relationships between data from the acquired data.

The visualization unit 204 is means for displaying, on a terminal 20 or the like used by a user, relationships between data inferred.

### Premise: Overall View of System Design

Before describing details of each processing module of the information processing apparatus 10, an overall view of system design will be described. Data acquired by the data acquisition unit 202 is information related to system design. Here, as a premise for explanation of information related to system design, an overall view of system development will be described.

A system design process often proceeds in order of requirement analysis, basic design, detailed design, implementation, and test. After the test ends, the process of the system branches into two routes in accordance with test results.

In a case where the test is passed, the process directly proceeds to release of code.

On the other hand, in a case where the test is not passed, the process proceeds to problem analysis.

After problem analysis, the necessity of a design change is judged. In a case where a design change is necessary, the range of influence is specified, and a redesign of related portions is performed. The redesign returns to the detailed design phase, and the process proceeds again from there. In a case where the design change is judged to be unnecessary, the process of the system returns to the implementation phase.

The above is the overall view of the system design process.

### Specific Examples of Information Related to System Design

The information related to the system design acquired by the data acquisition unit 202 is, for example, a deliverable in each phase of the above-mentioned system design process.

For example, in a requirement analysis phase, a requirement specification clarifying a system purpose, function requirements, and non-function requirements is created. In the specification, user stories, specific function requirements, performance requirements, and the like are described, and they serve as a foundation for design in subsequent phases.

For example, in a case where a design target is "an online bookstore system," a user story such as "As a user, the user wants to search for books by keyword," and a non-function requirement such as "A search response time shall be within one second" are included in the requirement specification.

In a basic design phase, a system architecture design document defining a structure of the entire system and main components is created. In the document, a system configuration diagram, a list of major components, a selected technology stack, and the like are included.

In the example of the above online bookstore system, a configuration diagram showing relationships of a web application, an API (Application Programming Interface) server, and a database, and major modules such as user management, book management, order management, and payment processing are defined.

In addition, in a basic design phase, technology selection such as using React.js for a front end, Node.js for a back end, and PostgreSQL for a database is also performed.

In a detailed design phase, documents such as a detailed design specification defining detailed specifications of each component, a database design specification, and an API specification are created. These documents include class diagrams, database schemas, detailed specifications of API endpoints, and the like.

In the example of the above online bookstore system, a class diagram defining attributes and methods of a book class, an order class, and a user class is created. In addition, a database schema showing structures and relationships of a user table, a book table, and an order table, and an API specification defining input parameters and a response format of a /api/books/{id} (GET) endpoint are created.

In an implementation phase, actual program code is created based on the design so far. As deliverables, source code and unit test code exist.

Specifically, components of a book search form implemented using React.js (BookSearchForm.js), API handlers related to books implemented with Node.js (bookController.js), and code of a database access layer (BookRepository.js), and the like are included. These pieces of code are implemented based on a detailed design document, and consistency with the design is ensured.

In a test phase, a test plan, a test result report, a bug report, and the like for verifying system functions and quality are created. These documents include unit test cases, integration test scenarios, load test results, and the like. In the test phase, it is confirmed whether or not the system satisfies the requirements described in the requirement specification.

For example, a unit test code of a book search function, an integration test scenario verifying a series of flows from user login to book purchase, and a graph showing a system response time in a case of simultaneous connection of a predetermined number of clients are created.

In a final release phase, documents related to deployment and operation of the system into a production environment are created. For example, a deployment plan, a user manual, an operation procedure document, and the like are created.

Specifically, Terraform code for automating deployment to a predetermined cloud service, a document in a predetermined format describing how to use the online bookstore system, and a workflow diagram detailing recovery procedures in case of a system down, and the like are created. These documents are indispensable for stable operation of the system and user support.

The data acquisition unit 202 is able to acquire deliverables and information of the above phases from a database or the like. For example, the database may hold this information in a graph format based on a hierarchical structure of system design. It should be noted that a designer or the like inputs information to be stored in the database into the information processing apparatus 10.

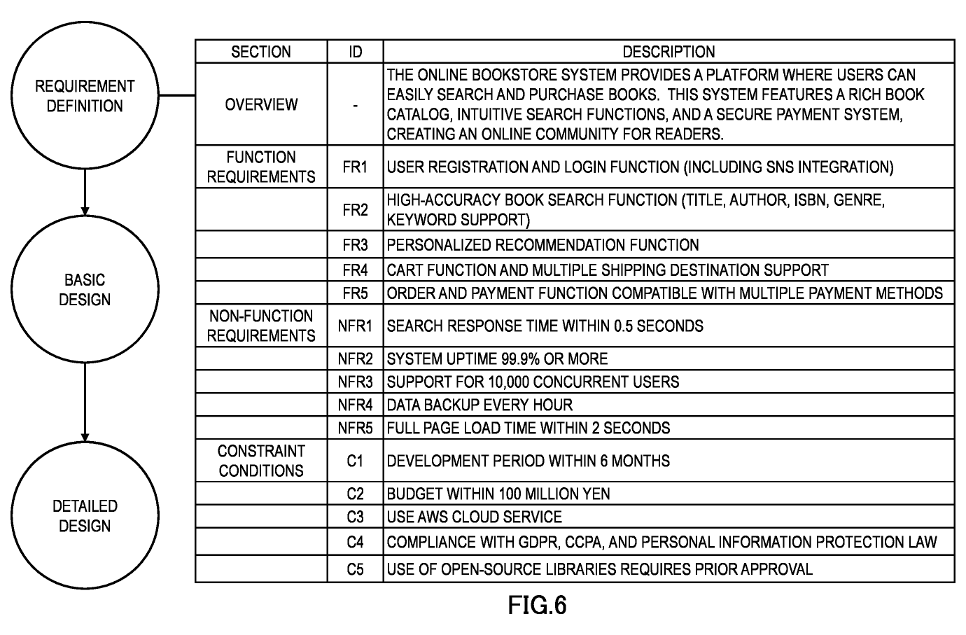

Here, a concept of a data storage format of the database will be described using FIG. 6.

FIG. 6 is a conceptual diagram illustrating a data structure from requirement definition to detailed design of the online bookstore system.

On the left side of FIG. 6, three circles "requirement definition," "basic design," and "detailed design" are arranged vertically, and arrows indicate their order. On the right side, a table showing details of the requirement definition is arranged.

The table shown on the right side of FIG. 6 is an example of data stored in a database corresponding to a requirement definition. The table corresponding to the requirement definition is composed of three columns: "section," "ID," and "description."

In the "section" column, "overview," "function requirements," "non-function requirements," and "constraint conditions" are described.

In the "ID" column, identifiers corresponding to respective requirements (FR1, FR2, or the like) are assigned.

In the "description" column, specific contents of respective requirements are described.

In the "overview" section described in the section column, it is explained that the system is an online bookstore platform, characterized by a rich book catalog, intuitive search functions, and a secure settlement system, and its purpose is to create an online community for book lovers.

In the "function requirements" section, five requirements from FR1 to FR5 are enumerated. These include a user registration and login function, an advanced book search function, a personalized recommendation function, a cart function with multiple delivery address support, and an order and settlement function corresponding to diverse payment methods.

In the "non-function requirements" section, five requirements from NFR1 to NFR5 are described. These include requirements related to search response time, system availability, number of simultaneously connected users, periodic data backup, page load time, and the like.

In the "constraint conditions" section, five conditions from C1 to C5 are shown. These describe a development period, a budget, use of a predetermined cloud service, compliance with personal information protection laws such as GDPR (General Data Protection Regulation) and CCPA (California Consumer Privacy Act), and a necessity of prior approval for the use of open-source libraries, and the like.

It should be noted that in FIG. 6, only table data of the requirement definition is described. However, the database may store data in the same manner in other system development phases such as "basic design" and "detailed design," or the like.

### Example of Display Screen 1 (Case of One Phase)

An example of a screen displayed by the visualization unit 204 based on the above-described data structure will be described.

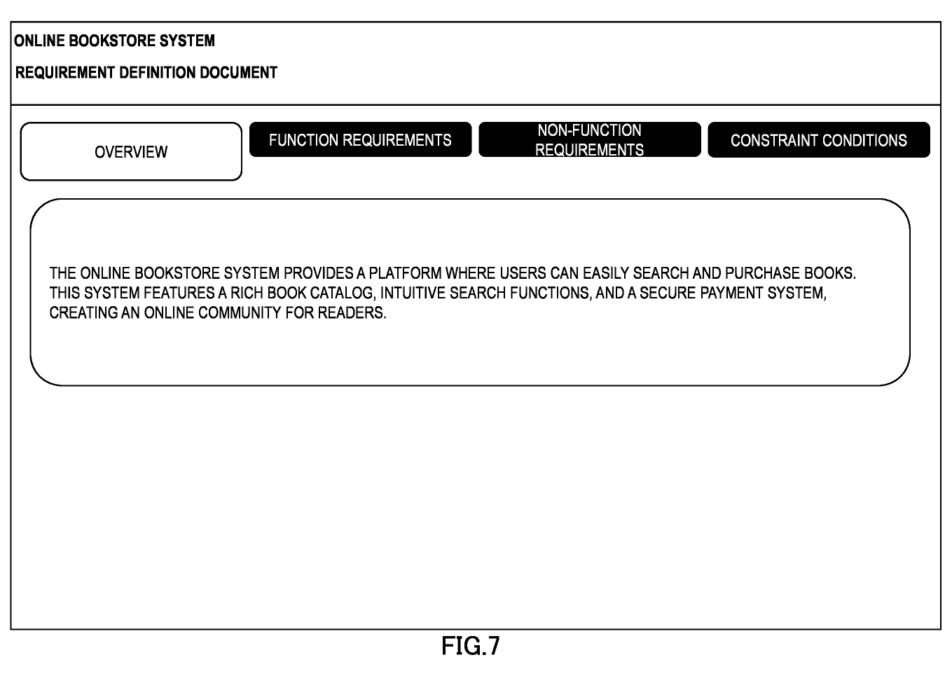

FIG. 7 is a diagram illustrating an example of a requirement definition document presentation screen.

At the top of FIG. 7, a large title "online bookstore system requirement definition document" is displayed. By the title, the user is able to immediately understand the nature of the document being viewed.

Below the title, four tabs are arranged, and from the left, "overview," "function requirements," "non-function requirements," and "constraint conditions" are arranged respectively. By tapping these tabs, the user is able to switch to a corresponding information section.

In the "overview" tab, an overall purpose and features of the online bookstore system are briefly described, and the user is able to grasp an outline direction of the project.

In a case where the tabs "function requirements," "non-function requirements," and "constraint conditions" are tapped, a list of requirements (requirement items) belonging to respective categories is displayed.

Each requirement item is composed of an identifier and a brief explanatory text of the requirement.

In a case where the user taps an item, a detailed description of a requirement corresponding to the tapped item is expanded and displayed. By tapping the same item again, the detailed description is collapsed. In this manner, information necessary for the user is efficiently provided.

In a case where the user scrolls the screen, requirement items that cannot be displayed simultaneously are able to be browsed. By such a layout, the user is able to grasp an overall view of the requirement definition document while accessing detailed information as necessary. As a result, efficient information management and browsing on a mobile device is realized.

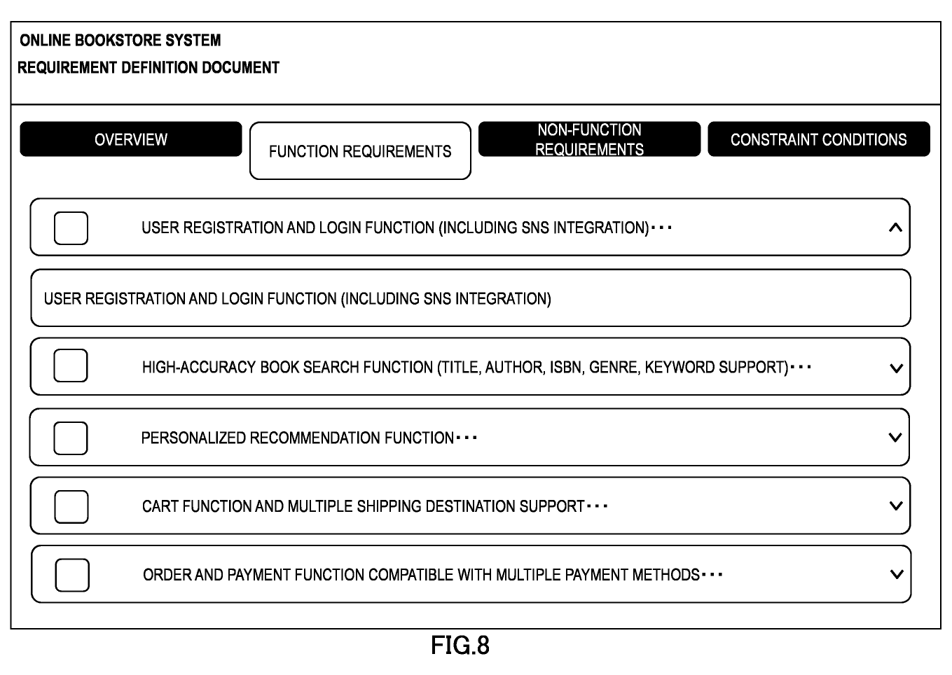

FIG. 8 is a diagram illustrating another example of the requirement definition document presentation screen.

FIG. 8 is a screen in a case where "function requirements" among the four tabs shown in FIG. 7 is selected.

On the screen, five function requirement items are displayed in a list format. Each item is collapsible, and in FIG. 8, the first item "user registration and login function (including SNS integration)" is expanded.

It should be noted that other items include "advanced book search function," "personalized recommendation function," "cart function with multiple delivery address support," and "order and settlement function corresponding to diverse payment methods."

The screen shown in FIG. 8 is designed so that the user is able to efficiently browse contents of one item (function requirements) in the requirement definition document and access detailed information as necessary.

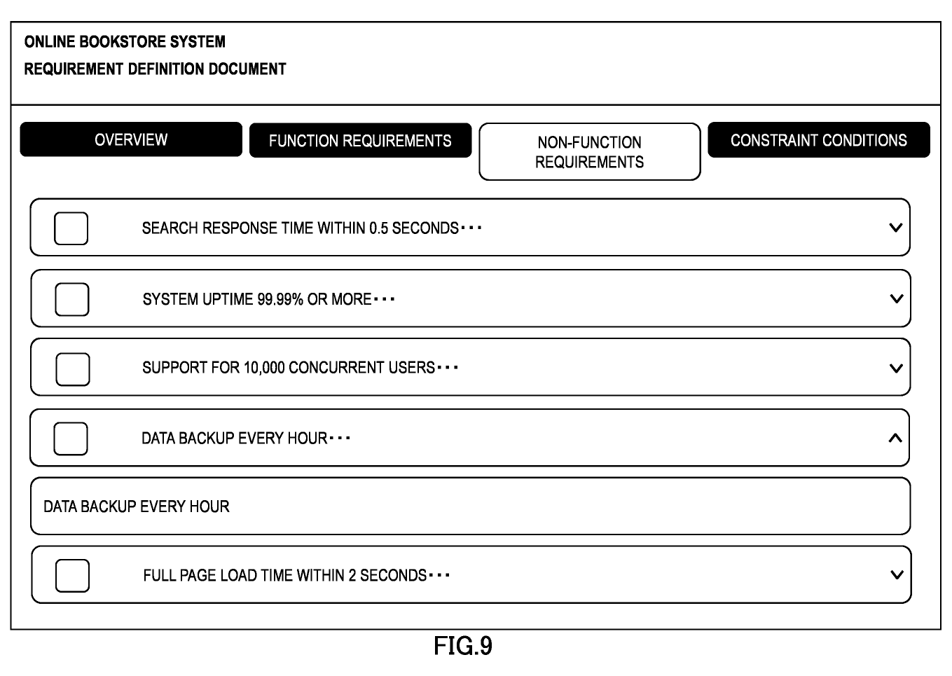

FIG. 9 is a diagram illustrating still another example of a requirement definition document presentation screen.

FIG. 9 is a screen in a case where "non-function requirements" among the four tabs shown in FIG. 7 is selected.

On the screen, five non-function requirement items are displayed in a list format. Each item is collapsible, and in FIG. 9, the fourth item "data backup is performed every hour" is expanded.

Other items include "search response time is within 0.5 seconds," "system availability is 99.99% or higher," "support for 10,000 concurrent users," and "page load time of all pages is within two seconds."

The screen is designed so that the user is able to efficiently browse contents of one item (non-function requirements) in the requirement definition document and access detailed information as necessary.

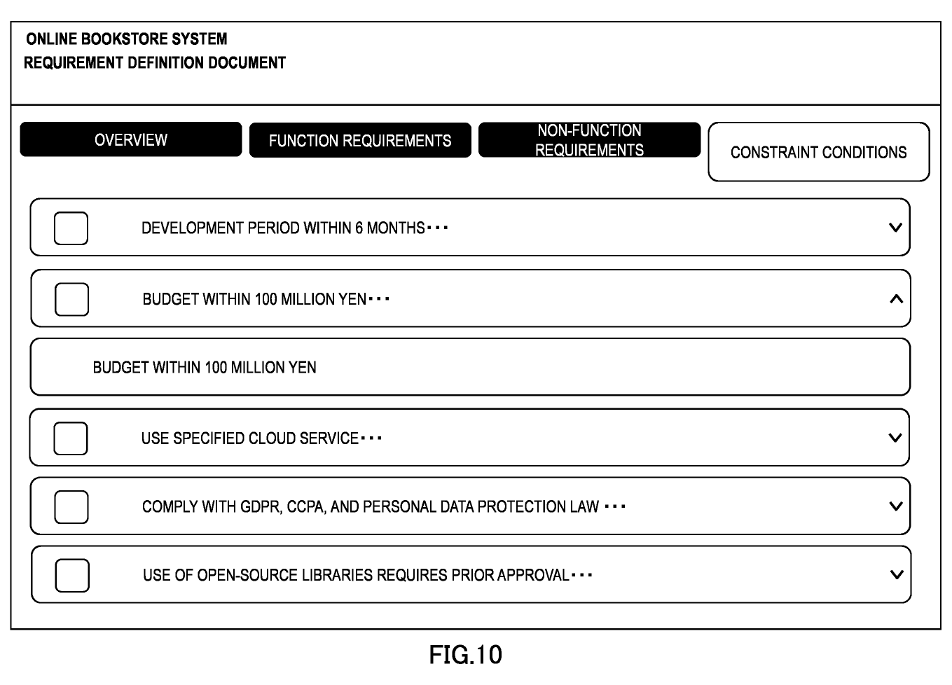

FIG. 10 is a diagram illustrating another example of a requirement definition document presentation screen.

FIG. 10 is a screen in a case where "constraint conditions" among the four tabs shown in FIG. 7 is selected.

On the screen, five constraint condition items are displayed in a list format. Each item is collapsible, and in FIG. 10, the second item "budget is within 100 million yen" is expanded.

Other items include "development period is within six months," "a predetermined cloud service shall be used," "GDPR, CCPA, and personal information protection laws shall be complied with," and "use of open-source libraries requires prior approval."

The screen is designed so that the user is able to efficiently browse contents of one item (constraint conditions) in the requirement definition document and access detailed information as necessary.

### Example of Display Screen 2 (Case of Showing a Relationship with Another Phase)

Based on the above-described data structure shown in FIG. 6, an example of a screen in which the visualization unit 204 displays information of a plurality of development phases will be described.

First, as a premise, an example of a data structure to be displayed will be described.

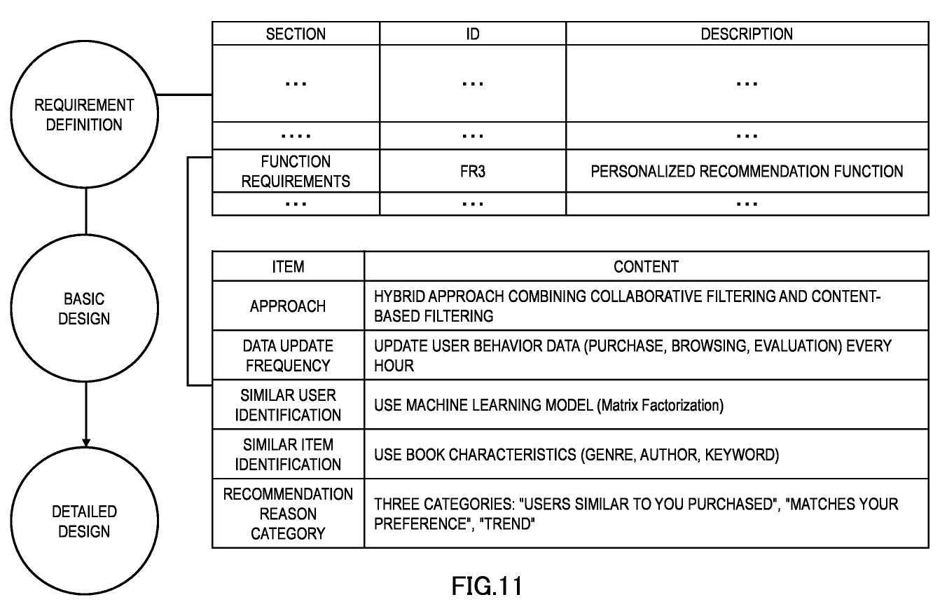

FIG. 11 illustrates an example of a data structure that the data acquisition unit 202 is able to acquire. In FIG. 11, three major phases, requirement definition, basic design, and detailed design, and relationships of data related thereto are illustrated.

Similar to FIG. 6, three circles are arranged vertically on the left side of FIG. 11, and each circle represents "requirement definition," "basic design," and "detailed design." These circles are connected by arrows and represent a flow of the development process.

On the right side of FIG. 11, two tables are arranged. An upper table shows a part of a requirement definition phase and is composed of three columns, "section," "ID," and "description." In the table, FR3 "personalized recommendation function" is described as an example of function requirements.

A lower table shows contents of a basic design phase and is composed of two columns, "item" and "contents." In the table, detailed information related to basic design of the recommendation function is described, and five items, approach, data update frequency, similar user identification, similar item identification, and recommendation reason categories are included.

FIG. 11 visually illustrates how function requirements defined in the requirement definition are embodied in the basic design.

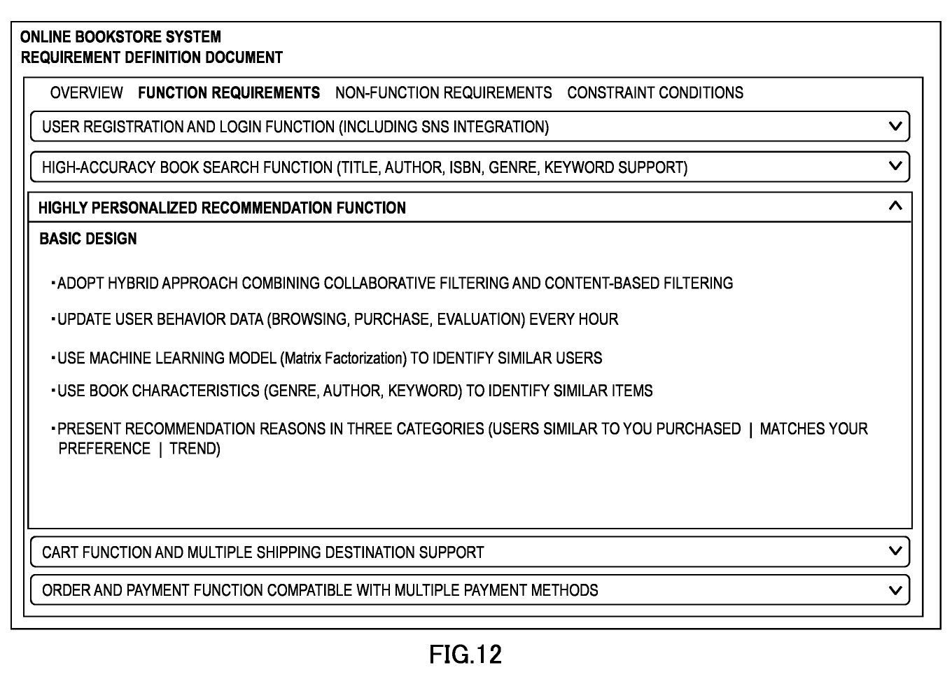

FIG. 12 is a diagram illustrating an example of a basic design presentation screen for displaying information of a basic design corresponding to the above-mentioned requirement definition.

At the top of FIG. 12, a title "online bookstore system requirement definition document" is arranged. Furthermore, below the title, four tabs, "overview," "function requirements," "non-function requirements," and "constraint conditions" are arranged side by side.

In a state shown in FIG. 12, the "function requirements" tab is selected, and five function requirement items are displayed in a list format. It should be noted that each item is collapsible.

Consider a case where the user selects a third item, "personalized recommendation function." The selection by the user is able to be performed by a click operation or a drag operation using a mouse or the like.

In this case, in the expanded item, detailed information related to a basic design of the corresponding function is described in bullet points. Specifically, adoption of a hybrid approach, update frequency of user behavior data, a method for identifying similar users, a method for identifying similar items, a method for displaying recommendation reasons, and the like are described.

In this manner, the basic design presentation screen visually illustrates a relationship between the requirement definition and the basic design, and is designed so that the user is able to efficiently browse information.

It should be noted that in FIG. 12, data related to the requirement definition and the basic design is disclosed, but presented contents are not limited to the requirement definition and the basic design. The visualization unit 204 may display information related to the basic design and the detailed design in the same manner as in the case of the requirement definition and the basic design, or may display information of source code implementing the detailed design.

In this manner, the visualization unit 204 is able to display an outline or display detailed information in displaying a correspondence structure regarding a design result and input information. Alternatively, the visualization unit 204 accepts a change of a display range at the same level regarding summarized information or detailed information (for example, expansion or collapse of an item, or parallel movement). That is, the visualization unit 204 has an interface for adjusting a range for displaying a correspondence structure (information presented to the user) in a form of summarization, detailing, and parallel movement of a display range at the same level (the interface is provided to the user). In addition, the adjustment is able to be performed at least by a click and a drag of a predetermined displayed location.

### Example of Display Screen 3 (Screen Reflecting a User Modification)

Based on the above-described data structure shown in FIG. 6, an example of a screen in a case where the data acquisition unit 202 accepts a modification from the user and reflects the modification will be described.

For example, consider a case where in the screen shown in FIG. 12, the user modifies "personalized recommendation function" to "highly personalized recommendation function."

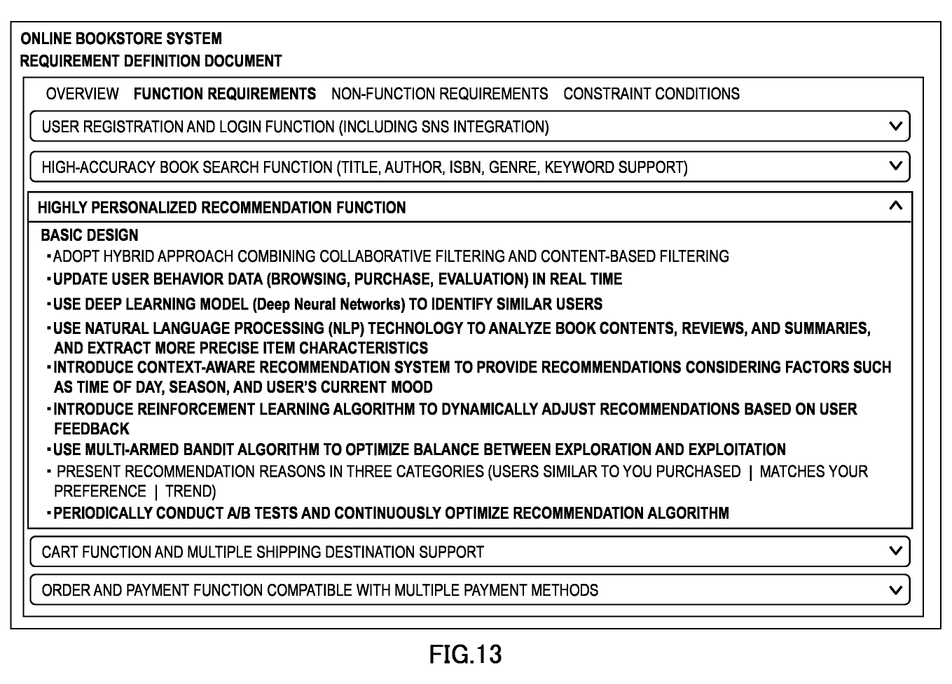

In this case, the visualization unit 204 may realize modification of relationship information by displaying a screen as shown in FIG. 13.

FIG. 13 is a diagram illustrating an example of a screen that displays areas to be modified of an online bookstore system.

At the top of the screen in FIG. 13, a title "online bookstore system" is described. Under the title, a subtitle "requirement definition document" is displayed.

On the screen shown in FIG. 13, four tabs (overview, function requirements, non-function requirements, and constraint conditions) are described. In a state shown in FIG. 13, the "function requirements" tab is selected. In addition, in FIG. 13, a list of function requirements is displayed, and five items are displayed.

In FIG. 13, a third item "highly personalized recommendation function" is expanded, and details of the basic design thereof are displayed in bullet points. In the details of the basic design, there are items displayed in bold characters such as "real-time update of user behavior data," and the like.

The items displayed in bold characters are items in which a change is required in the basic design in a case where the user changes "personalized recommendation function" to "highly personalized recommendation function" in the requirement definition document.

In this manner, in a case where any one of addition, change, or deletion of a design result or input information is performed, the visualization unit 204 has an interface for displaying a list of other design results or input information in which any one of addition, change, or deletion is required due to any one of addition, change, or deletion of the design result or the input information. For example, the visualization unit 204 displays on the terminal 20 a screen as shown in FIG. 13. In FIG. 13, a modification of the requirement definition document is performed, and a list of basic designs affected by the modification (respective items of the affected basic design) is displayed.

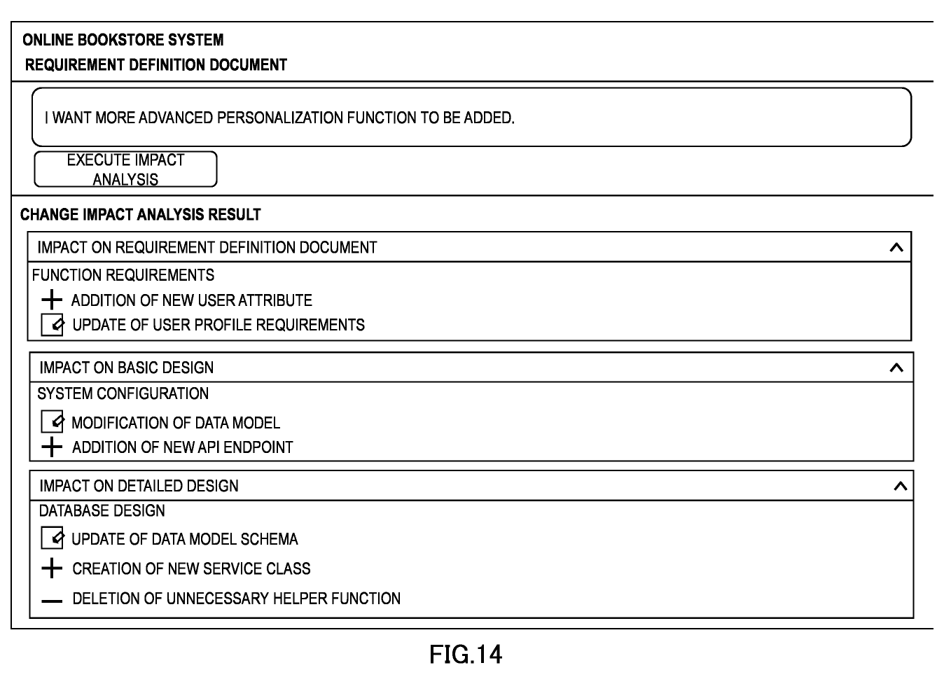

In addition, another example of a screen reflecting a modification will be described using FIG. 14. FIG. 14 is a diagram illustrating an example of a screen displaying change impact analysis of the online bookstore system.

In an upper section of the screen shown in FIG. 14, a rectangular text area for inputting change contents is set. In an example of FIG. 14, text "I would like a more advanced personalization function to be added." is input into the text area.

The user is able to transmit change contents of the system to the data acquisition unit 202 by inputting an arbitrary character string into the text area.

Furthermore, below the text area, a rectangular "execute impact analysis" button is described. In a case where the user presses the button, the inference unit 203 of the information processing apparatus 10 performs an analysis of the modification policy.

In a lower section of the button, "change impact analysis result" is displayed, and three collapsible panels are included.

In the "impact on requirement definition document" panel, under a subcategory "function requirements," an item with a plus icon and "addition of new user attribute," and an item with an edit icon (an icon described with a notebook and a pencil) and "update of user profile requirements" are listed.

In the "impact on basic design" panel, under the subcategory of "system configuration," there exist items including an edit icon with "modification of data model" and a plus icon with "addition of new API endpoint."

In the "impact on detailed design" panel, under the subcategory of "database design," items are listed including an edit icon with "update of database schema," a plus icon with "creation of new service class," and a minus icon with "deletion of unnecessary helper function."

By the screen design shown in FIG. 14, the impact of system changes across a plurality of phases is visually displayed in an easily understandable manner. It should be noted that the plus icon indicates an addition of an item, the edit icon indicates an update of an item, and the minus icon indicates a deletion of an item.

In addition, by means of the collapsible panel design, the user is able to expand only the necessary information and confirm its content. As a result, the user is able to efficiently analyze the impact of large-scale system changes in a plurality of phases and accurately identify the necessary tasks.

In this way, in a case where the user inputs a planned location at which any one of addition, change, or deletion of design results or input information is to be performed, a visualization unit 204 has an interface that displays a list of other design results or input information for which any one of addition, change, or deletion becomes necessary along with the addition, change, or deletion of the design results or input information. For example, the visualization unit 204 acquires, by using the text area shown in FIG. 14, a planned location at which the user is to perform any one of addition, change, or deletion of design results or input information.

### Details of operation of inference unit 203

The above is an explanation related to the user interface according to the first example embodiment.

Here, details will be described with respect to the operation of the inference unit 203 for realizing the above-mentioned user interface.

The inference unit 203 infers relationships between data from the acquired data. Specifically, the operation of the inference unit 203 mainly uses text analysis employing a machine learning model and the construction and exploration of a knowledge graph.

For example, the inference unit 203, first, by applying natural language processing technology to documents such as a requirement definition document, a basic design document, and a detailed design document acquired from the data acquisition unit 202, extracts important concepts and elements within each document.

For example, the inference unit 203 extracts a function requirement "personalized recommendation function" from the requirement definition document, and identifies related design elements such as "hybrid approach" and "user behavior data update" from the basic design document.

Next, the inference unit 203 analyzes the relationships between these extracted elements and constructs a knowledge graph. In the knowledge graph, for example, a node "personalized recommendation function" is connected by an edge to a node "hybrid approach," thereby representing a design dependency.

The inference unit 203, by using the knowledge graph, infers how a change in one element affects other elements.

For example, consider a case where the "personalized recommendation function" in the requirement definition document is changed to a "highly personalized recommendation function." In this case, the inference unit 203 explores other nodes (elements of the basic design or the detailed design) connected to this node (the node corresponding to the "personalized recommendation function") on the knowledge graph, and identifies the elements that may be affected.

Furthermore, the inference unit 203, by using a machine learning model, compares with past project cases and a knowledge base of ordinary software development, and evaluates the degree of impact and the importance of the change.

For example, the inference unit 203 determines that it is highly likely that a change in the "update frequency of user behavior data" will be required, and at the same time estimates the impact on system performance accompanying the change.

Based on these analysis results, the inference unit 203 determines the locations where changes are required and their priority, and generates change impact analysis results as shown in FIG. 14. In addition, during the process of generating the change impact analysis results, the inference unit 203 continuously learns new information and updates the knowledge graph and the inference model. By updating the knowledge graph and the inference model, improvements are continuously made so that more accurate inferences can be performed.

It should be noted that, in a case where the data acquired by the data acquisition unit 202 is structured data as shown in FIG. 6 or FIG. 11, the inference unit 203 may only transmit information related to the structured data to the visualization unit 204. Alternatively, the method by which the visualization unit 204 infers relationships between data is not limited to text analysis as described above, and a large language model may be used.

Here, a case where a large language model (LLM; Large Language Model) is used will be described.

First, the data acquisition unit 202 acquires documents such as a requirement definition document, a basic design document, and a detailed design document.

Next, the inference unit 203 provides these documents as input to the large language model. For example, the inference unit 203 may generate a prompt such as "In a case where the 'personalized recommendation function' in the requirement definition document is changed to a ‘highly personalized recommendation function,’ what kind of impact will occur on the basic design and the detailed design?" and input it into the large language model.

The large language model analyzes the impact of a change by understanding the given context based on information related to system development stored in a database and by utilizing ordinary knowledge in software development.

The large language model generates an answer such as, for example, "In the basic design, it is necessary to change the update frequency of user behavior data to real time. In addition, in the detailed design, it is necessary to implement a more advanced machine learning algorithm, and expansion of the database schema should also be considered."

The inference unit 203 analyzes the answer obtained from the large language model and converts it into a structured format. For example, the inference unit 203 converts the obtained answer into a format such as {Basic design: [Change of update frequency of user behavior data], Detailed design: [Advancement of machine learning algorithm, Expansion of database schema]}.

Finally, the visualization unit 204 receives the structured data from the inference unit 203 and generates a change impact analysis result screen as shown in FIG. 14.

As described above, the data acquisition unit 202 acquires relationship information between a plurality of design tasks constituting a system design flow, design results of the design tasks, and input information including at least natural language for executing the design tasks. The relationship information between the plurality of design tasks is, for example, structured data as shown in FIG. 11. The design result of the design task is, for example, a deliverable in a design phase. The input information including at least natural language for executing the design task is, for example, information described in a requirement definition document or a basic design document.

The inference unit 203, based on the relationship information, the design result, and the input information acquired by the data acquisition unit 202, infers correspondences spanning design tasks for each part of the design result and the input information. For example, the inference unit 203 infers correspondences between important concepts and elements obtained from the requirement definition document and design elements related to the important elements of the requirement definition document among the elements described in the basic design document.

The visualization unit 204 displays, based on the correspondence relationships inferred by the inference unit 203, a correspondence structure with respect to the design results and the input information over an entirety of the system. For example, the visualization unit 204 displays the correspondence structure by using a user interface as shown in FIG. 12 or FIG. 13.

The storage unit 205 is means for storing information necessary for the operation of the information processing apparatus 10. For example, the above-described database is constructed in the storage unit 205.

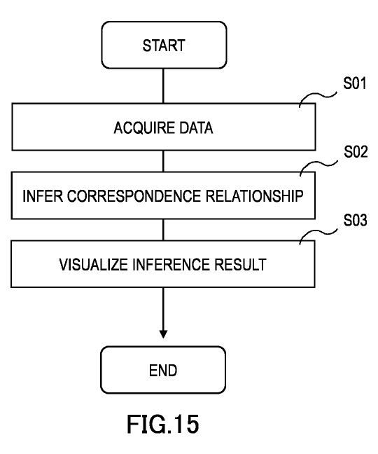

Summarizing the operation of the information processing apparatus 10, it is as shown in the flowchart of FIG. 15.

The data acquisition unit 202 of the information processing apparatus 10 acquires data from a database or from a user (step S01).

The inference unit 203 of the information processing apparatus 10 infers relationships between data from the acquired data (step S02).

The visualization unit 204 of the information processing apparatus 10 displays the inferred relationships between the data on a display apparatus such as the terminal 20 used by the user (visualize inference result; step S03).

### Terminal

A detailed description of the terminal 20 will be omitted. Examples of the terminal 20 include a portable terminal device such as a smartphone, a portable phone, a game console, or a tablet and a computer (a personal computer or a laptop computer). The terminal 20 can be any equipment or device that is capable of accepting an operation of the user and communicating with the information processing apparatus 10.

As described above, the information processing apparatus 10 according to the first example embodiment infers correspondence relationships spanning a plurality of design tasks by using relationship information or the like between the design tasks in a development process. The information processing apparatus 10 visualizes and displays a correspondence structure over an entirety of the system based on the inferred correspondence relationships. As a result, relationships of each stage of the development process and visibility of areas to be modified are improved.

### Second Example Embodiment

Next, a second example embodiment will be described in detail with reference to drawings.

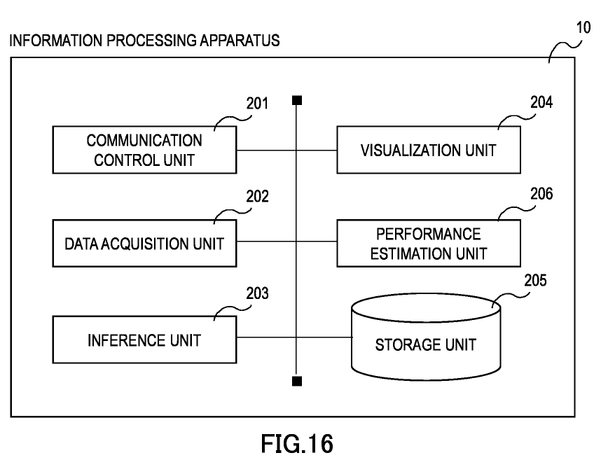

The information processing apparatus 10 according to the second example embodiment differs from the information processing apparatus 10 according to the first example embodiment in that it includes a performance estimation unit 206 (see FIG. 16). By the performance estimation unit 206 of the information processing apparatus 10 according to the second example embodiment, how performance of the entire system fluctuates in a case where a user who is a system developer makes a modification is visualized.

The following description will be made with a focus on the difference between the first example embodiment and the second example embodiment.

The performance estimation unit 206 is means for estimating performance with respect to the result of the inference unit 203.

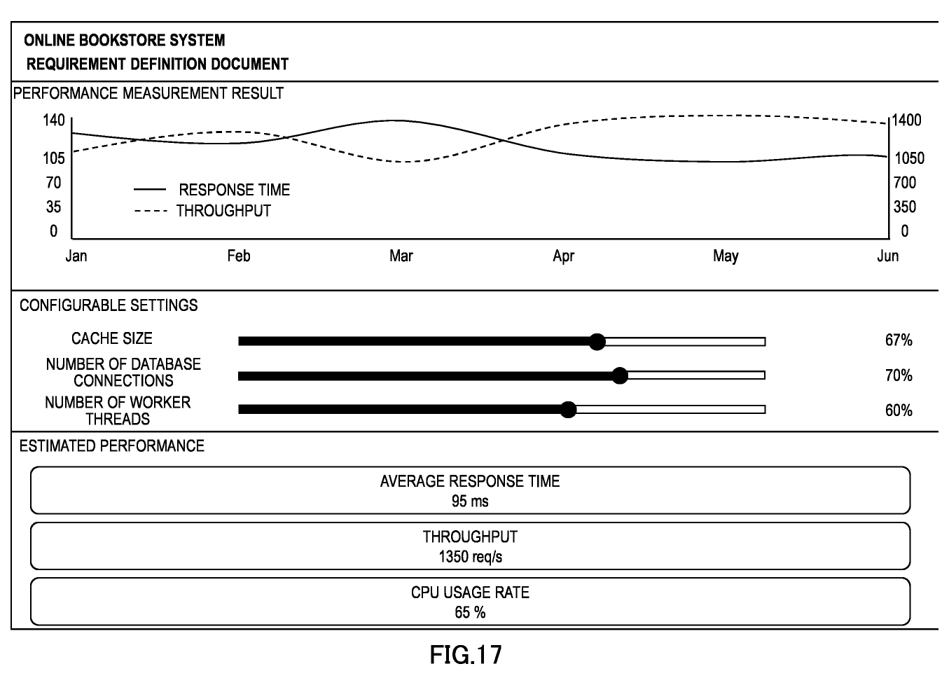

The visualization unit 204 according to the second example embodiment is able to present the estimated performance to a user. A screen in which the result of the performance estimation unit 206 is displayed will be described with reference to FIG. 17.

FIG. 17 illustrates a system performance and setting interface of an online bookstore system displayed by the visualization unit 204. The screen of FIG. 17 is divided into three main sections.

In the "performance transition result" graph at the top, transitions of the response time (a solid line in the graph) and the throughput (a dashed line in the graph) from January to June are displayed. In the top graph, the response time is indicated on the left axis and the throughput is indicated on the right axis, and variations for each month are described.

In the "configurable settings" section in the middle, three parameters of a cache size (67%), a number of database connections (70%), and a number of worker threads (60%) are configured to be adjustable by sliders. In a case where these settings are changed, how the system performance will be changed is indicated to the user.

In the "estimated performance" section at the bottom, estimated performance values based on the current settings are displayed. Specifically, in the section, it is described that the average response time is 95 milliseconds, the throughput is 1350 requests per second, and the CPU usage is 65%. These values may be dynamically updated according to the setting changes at the top.

Throughout the entire screen shown in FIG. 17, a system administrator is able to monitor performance transitions, adjust settings as necessary, and confirm the impact in real time. For example, from the transition of the graph, it can be understood that throughput decreased and response time increased in March, and thereafter an improvement trend is observed from April onward.

In addition, FIG. 17 suggests that in the current settings, each parameter is set to a medium level, and there is room for further optimization.

In this way, the screen shown in FIG. 17 provides a user with important information for understanding the current status of the system and for performance tuning. That is, the information processing apparatus 10 is able to present to a user who is a system developer, through the screen shown in FIG. 17, how the performance will be changed in a case where the system is modified.

In this way, the visualization unit 204 provides an interface that allows changes of predetermined parameters in a final system corresponding to a deliverable. For example, as shown in FIG. 17, the visualization unit 204 provides an interface in which parameters such as a cache size are changeable. Furthermore, the visualization unit 204 has an interface (provides an interface) that displays a list including at least one of performance measurement results and estimated performance.

Alternatively, the visualization unit 204 may have an interface that, in a case where a user inputs a desired change area in at least one of the performance measurement results and the estimated performance, displays design results or input information for which any one of an addition, change, or deletion becomes necessary in accordance with the input of the desired change area. For example, in the screen shown in FIG. 17, the visualization unit 204 may display together a text area and a change impact analysis result section as shown in FIG. 14.

### Performance Estimation Method

A specific method by which the performance estimation unit 206 performs estimation as described above will be explained.

The performance estimation unit 206 may perform the above estimation by combining a plurality of methods.

As one example, past system log data is utilized and a machine learning model is constructed. Specifically, a regression model is obtained through training, in which configuration parameters such as cache size, number of database connections, and number of worker threads are used as inputs, and response time, throughput, and CPU usage rate are used as outputs.

For example, by using ensemble learning methods such as a random forest or gradient boosting, complex interactions among parameters are captured.

Alternatively, the performance estimation unit 206 may utilize simulation technology to model system behavior under various load patterns. For example, a simulator based on existing technology is constructed, and the performance estimation unit 206 predicts request processing delays and resource utilization under different settings by using the simulator. As a result, various scenarios are tested without imposing a load on the actual system.

Alternatively, by integrating the methods described above, the performance estimation unit 206 may perform estimation with high accuracy and flexibility.

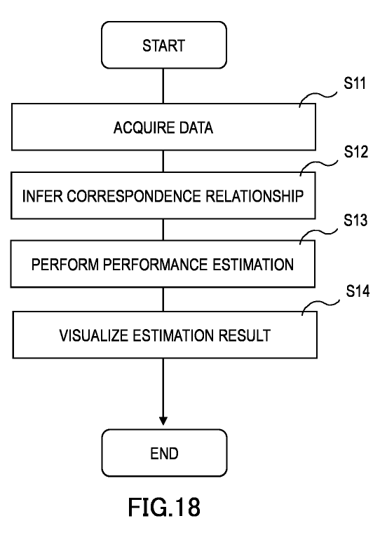

To summarize the operation of the information processing apparatus 10 according to the second example embodiment, it is as shown in the flowchart of FIG. 18.

The data acquisition unit 202 of the information processing apparatus 10 acquires data from a database or from a user (step S11).

The inference unit 203 of the information processing apparatus 10 infers (estimates) relationships among the acquired data (step S12).

The performance estimation unit 206 of the information processing apparatus 10 estimates the performance with respect to the result of the inference unit 203 (perform performance estimation; step S13).

The visualization unit 204 of the information processing apparatus 10 displays the estimated performance on a display apparatus such as the terminal 20 used by the user (visualize estimation result; step S14).

As described above, the information processing apparatus 10 according to the second example embodiment visualizes and displays how performance of the entire system fluctuates in a case where a user makes a modification to a design result. As a result, the user is able to perform efficient system development.

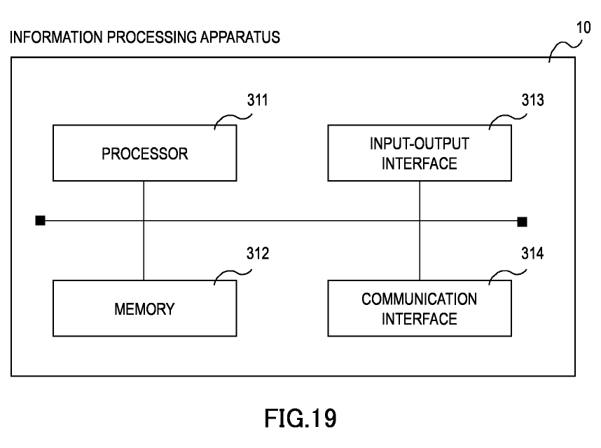

Next, a hardware configuration of an individual apparatus that constitutes the information processing system will be described. FIG. 19 is a diagram illustrating an example of a hardware configuration of the information processing apparatus 10.

The information processing apparatus 10 can be configured by an information processing apparatus (a so-called computer) and has a configuration illustrated as an example in FIG. 19. For example, the information processing apparatus 10 includes a processor 311, a memory 312, an input-output interface 313, a communication interface 314, and the like. The above-described components such as the processor 311 are connected via an internal bus or the like and are configured to be capable of communicating with each other.

However, the configuration shown in FIG. 19 is not intended to limit the hardware configuration of the information processing apparatus 10. The information processing apparatus 10 may include hardware not illustrated or may be configured without the input-output interface 313 if desired. In addition, the number of components, such as the number of processors 311, included in the information processing apparatus 10 is not limited to the example illustrated in FIG. 19. For example, a plurality of processors 311 may be included in the information processing apparatus 10.

The processor 311 is a programmable device such as a CPU (Central Processing Unit), an MPU (Micro Processing Unit), a DSP (Digital Signal Processor), a TPU (Tensor Processing Unit), a GPU (Graphics Processing Unit), or the like. Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), and the like. The memory 312 stores an OS program, an application program, and various kinds of data.

The input-output interface 313 is an interface for a display apparatus or an input apparatus, which is not shown in the figure. The display apparatus is, for example, a liquid crystal display or the like. For example, the input apparatus is an apparatus that receives user operations, and examples of the input apparatus include a keyboard, a mouse, and the like

The communication interface 314 is a circuit, a module, and the like for performing communication with other apparatuses. For example, the communication interface 314 includes a NIC (Network Interface Card) or the like.

The functions of the information processing apparatus 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present disclosure can be embodied as a computer program product. In addition, the above program may be updated by downloading a program via a network or by using a storage medium in which a program is stored. In addition, the above processing modules may be realized by semiconductor chips.

It should be noted that the terminal 20 can also be configured by an information processing apparatus in the same manner as the information processing apparatus 10, and since its basic hardware configuration is not different from that of the information processing apparatus 10, the description thereof will be omitted.

The information processing apparatus 10 includes a computer, and the functions of the information processing apparatus 10 can be realized by causing the computer to execute a program. In addition, the information processing apparatus 10 executes a control method of the information processing apparatus 10 by using this program.

### Variations

It should be noted that the configurations, operations, and the like of the information processing system described in the above example embodiments are examples, and are not intended to limit the configuration and the like of the system.

In the above example embodiments, the information processing apparatus 10 has been described by taking as an example a case where it has been realized as a server in a server-client system. However, the information processing apparatus 10 may also be realized by the terminal 20 of a user in which a predetermined application is installed.

In the above example embodiment, a case has been described where a database is configured inside the information processing apparatus 10, but the database may be constructed in an external database server or the like. That is, some of the functions of the information processing apparatus 10 may be implemented in another apparatus. More specifically, the "visualization unit (visualization means)" and the like, described above, can be implemented in any of the apparatuses included in the system.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present disclosure has been made apparent by the above description. That is, the present disclosure is suitably applicable, for example, to an information processing system that supports system design by a user or the like.

### Supplementary Note 1

An information processing apparatus including:

a data acquisition means that acquires relationship information between a plurality of design tasks constituting a design flow of a system, design results of the design tasks, and input information for executing the design tasks, the input information including at least natural language;

an inference means that infers, based on the acquired relationship information, design results, and input information, correspondence relationships spanning the design tasks with respect to each part of the design results and the input information; and

a visualization means that displays, based on the inferred correspondence relationships, a correspondence structure with respect to the design results and the input information over an entirety of the system.

### Supplementary Note 2

The information processing apparatus according to supplementary note 1, wherein

the visualization means has an interface for adjusting a range for displaying the correspondence structure regarding the design results and the input information in a form of summarization, detailing, and parallel movement of a display range at same level, and

wherein the adjusting is able to be performed at least by a click and a drag of a predetermined displayed location.

### Supplementary Note 3

The information processing apparatus according to supplementary note 1 or 2, wherein

the visualization means has an interface that displays a list of other design results or input information for which any one of addition, change, or deletion becomes necessary along with the addition, change, or deletion of the design results or the input information in a case where any one of the addition, change or deletion of the design results or the input information has been performed or a user inputs a planned location at which any one of the addition, change, or deletion of the design results or the input information is to be performed.

### Supplementary Note 4

The information processing apparatus according to supplementary note 1 or 2, wherein

the visualization means has an interface, the interface allowing changes in a final system corresponding to a deliverable, that displays a list including at least one of performance measurement results and estimated performance.

### Supplementary Note 5

The information processing apparatus according to supplementary note 1 or 2, wherein

the visualization means has an interface, the interface allowing changes in a final system corresponding to a deliverable, that displays, in a case where a user inputs a desired change area in at least one of performance measurement results and estimated performance, the design results or the input information for which any one of the addition, change, or deletion becomes necessary in accordance with the input of the desired change area.

### Supplementary Note 6

An information processing method of an information processing apparatus, the information processing method including:

acquiring relationship information between a plurality of design tasks constituting a design flow of a system, design results of the design tasks, and input information for executing the design tasks, the input information including at least natural language;

inferring, based on the acquired relationship information, design results, and input information, correspondence relationships spanning the design tasks with respect to each part of the design results and the input information; and

displaying, based on the inferred correspondence relationships, a correspondence structure with respect to the design results and the input information over an entirety of the system.

### Supplementary Note 7

A program causing a computer mounted on an information processing apparatus to perform processing for:

acquiring relationship information between a plurality of design tasks constituting a design flow of a system, design results of the design tasks, and input information for executing the design tasks, the input information including at least natural language;

inferring, based on the acquired relationship information, design results, and input information, correspondence relationships spanning the design tasks with respect to each part of the design results and the input information; and

displaying, based on the inferred correspondence relationships, a correspondence structure with respect to the design results and the input information over an entirety of the system.

In addition, a part or all of the configurations described in supplementary note 2 to supplementary note 5, which have depended on supplementary note 1 described above, may also depend on supplementary note 6 and supplementary note 7 in the same dependency relationship as supplementary note 2 to supplementary note 5. Furthermore, not limited to supplementary note 1, supplementary note 6, and supplementary note 7, within a scope without departing from the above-described embodiments, a part or all of the configurations described as supplementary notes may similarly depend on various hardware, software, various recording means for recording software, or systems.

The entire disclosure of the above patent literature is incorporated herein by reference thereto. While the example embodiments of the present disclosure have thus been described, the present disclosure is not limited to these example embodiments. It is to be understood to those skilled in the art that these example embodiments are only examples and that various variations are possible without departing from the scope and sprit of the present disclosure. That is, the present disclosure of course includes various variations and modifications that could be made by those skilled in the art in accordance with the overall disclosure including the claims and the technical concept.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

What is claimed is:

1. An information processing apparatus comprising:
at least one memory storing a set of instructions; and
at least one processor configured to execute the set of instructions to:
acquire relationship information between a plurality of design tasks constituting a design flow of a system, design results of the design tasks, and input information for executing the design tasks, the input information including at least natural language;
infer, based on the acquired relationship information, design results, and input information, correspondence relationships spanning the design tasks with respect to each part of the design results and the input information; and
display, based on the inferred correspondence relationships, a correspondence structure with respect to the design results and the input information over an entirety of the system.

2. The information processing apparatus according to claim 1, wherein
the at least one processor is further configured to execute the set of instructions to realize an interface for adjusting a range for displaying the correspondence structure regarding the design results and the input information in a form of summarization, detailing, and parallel movement of a display range at same level, and
wherein the adjusting is able to be performed at least by a click and a drag of a predetermined displayed location.

3. The information processing apparatus according to claim 1, wherein
the at least one processor is further configured to execute the set of instructions to realize an interface that displays a list of other design results or input information for which any one of addition, change, or deletion becomes necessary along with the addition, change, or deletion of the design results or the input information in a case where any one of the addition, change or deletion of the design results or the input information has been performed or a user inputs a planned location at which any one of the addition, change, or deletion of the design results or the input information is to be performed.

4. The information processing apparatus according to claim 1, wherein
the at least one processor is further configured to execute the set of instructions to realize an interface, the interface allowing changes in a final system corresponding to a deliverable, that displays a list including at least one of performance measurement results and estimated performance.

5. The information processing apparatus according to claim 1, wherein
the at least one processor is further configured to execute the set of instructions to realize an interface, the interface allowing changes in a final system corresponding to a deliverable, that displays, in a case where a user inputs a desired change area in at least one of performance measurement results and estimated performance, the design results or the input information for which any one of the addition, change, or deletion becomes necessary in accordance with the input of the desired change area.

6. An information processing method of an information processing apparatus, the information processing method comprising:
acquiring relationship information between a plurality of design tasks constituting a design flow of a system, design results of the design tasks, and input information for executing the design tasks, the input information including at least natural language;
inferring, based on the acquired relationship information, design results, and input information, correspondence relationships spanning the design tasks with respect to each part of the design results and the input information; and
displaying, based on the inferred correspondence relationships, a correspondence structure with respect to the design results and the input information over an entirety of the system.

7. The information processing method according to claim 6, further comprising realizing an interface for adjusting a range for displaying the correspondence structure regarding the design results and the input information in a form of summarization, detailing, and parallel movement of a display range at same level, and
wherein the adjusting is able to be performed at least by a click and a drag of a predetermined displayed location.

8. The information processing method according to claim 6, further comprising realizing an interface that displays a list of other design results or input information for which any one of addition, change, or deletion becomes necessary along with the addition, change, or deletion of the design results or the input information in a case where any one of the addition, change or deletion of the design results or the input information has been performed or a user inputs a planned location at which any one of the addition, change, or deletion of the design results or the input information is to be performed.

9. The information processing method according to claim 6, further comprising realizing an interface, the interface allowing changes in a final system corresponding to a deliverable, that displays a list including at least one of performance measurement results and estimated performance.

10. The information processing method according to claim 6, further comprising realizing an interface, the interface allowing changes in a final system corresponding to a deliverable, that displays, in a case where a user inputs a desired change area in at least one of performance measurement results and estimated performance, the design results or the input information for which any one of the addition, change, or deletion becomes necessary in accordance with the input of the desired change area.

11. A non-transitory computer-readable storage medium storing a program causing a computer mounted on an information processing apparatus to perform processing for:
acquiring relationship information between a plurality of design tasks constituting a design flow of a system, design results of the design tasks, and input information for executing the design tasks, the input information including at least natural language;
inferring, based on the acquired relationship information, design results, and input information, correspondence relationships spanning the design tasks with respect to each part of the design results and the input information; and
displaying, based on the inferred correspondence relationships, a correspondence structure with respect to the design results and the input information over an entirety of the system.
